(19) United States
(12) Patent Application Publication
(10) Pub. No.: US 2024/0364625 A1
(43) Pub. Date: Oct. 31, 2024

(54) EFFICIENT VIRTUAL ADDRESS LEARNING IN OVERLAY NETWORK

(71) Applicant: Hewlett Packard Enterprise Development LP, Spring, TX (US)

(72) Inventors: Saumya Dikshit, Bangalore (IN); N V M Kishore Tanuku, Bangalore (IN)

(21) Appl. No.: 18/141,048

(22) Filed: Apr. 28, 2023

(51) Int. Cl. H04L 45/586; H04L 45/00; H04L 45/64

(52) U.S. Cl. CPC H04L 45/586; H04L 45/64; H04L 45/72

(57) ABSTRACT

A system for efficient multicast forwarding at a switch is provided. During operation, the switch can maintain a first tunnel with a first switch in a first overlay tunnel fabric, and a second tunnel with a second switch in a second overlay tunnel fabric. The switch can operate as the gateway for both fabrics. The system can obtain a first fabric identifier and a second fabric identifier from multicast control packets received via the first and second tunnels, respectively. A fabric identifier can uniquely identify a fabric. The system can then store, in a data structure, a first network address of the first switch and a second network address of the second switch in association with the first and second fabric identifiers, respectively. The system can determine whether to forward multicast traffic to either one of the first and second fabrics based on the first and second fabric identifiers, respectively.

### BACKGROUND

### Field

The present disclosure relates to communication networks. More specifically, the present disclosure relates to a method and system for efficiently learning a virtual address (e.g., without duplication) in a distributed tunnel fabric.

### BRIEF DESCRIPTION OF THE FIGURES

FIG. 1A illustrates an example of an overlay network facilitating efficient learning of virtual addresses, in accordance with an aspect of the present application.

FIG. 1B illustrates an example of a switch in a distributed tunnel fabric efficiently learning and distributing a virtual address and an associated priority value, in accordance with an aspect of the present application.

FIG. 2 illustrates an example of an overlay route packet for notifying a virtual address and an associated priority value in an overlay network, in accordance with an aspect of the present application.

FIG. 3 illustrates an example of an efficient failover for a virtual address based on associated priority values, in accordance with an aspect of the present application.

FIG. 4A presents a flowchart illustrating the process of a switch learning a virtual address and an associated priority value, in accordance with an aspect of the present application.

FIG. 4B presents a flowchart illustrating the process of a switch distributing a virtual address and an associated priority value in an overlay network, in accordance with an aspect of the present application.

FIG. 4C presents a flowchart illustrating the process of a switch programming a virtual address based on an associated priority value, in accordance with an aspect of the present application.

FIG. 5 presents a flowchart illustrating the process of a switch facilitating failover associated with a virtual address, in accordance with an aspect of the present application.

FIG. 6 illustrates an example of a switch supporting efficient learning of virtual addresses, in accordance with an aspect of the present application.

In the figures, like reference numerals refer to the same figure elements.

### DETAILED DESCRIPTION

In various Internet applications, a virtual address is frequently used to facilitate high availability among a set of devices. The virtual address can be a virtual media access control (MAC) address or an Internet Protocol (IP) address. Typically, the virtual address is associated with each of the set of devices where one or more of these devices can actively use the virtual address. For example, a plurality of devices may operate as a single virtual device based on the Virtual Router Redundancy Protocol (VRRP). One of these can be the primary device that may operate as the active device while others operate as standby devices. The devices associated with the virtual address can be allocated a corresponding priority value. The primary device can then be selected based on the priority values. Hence, the priority values can indicate the order of association between the virtual address and the primary device.

Efficiently learning and programming the virtual address can improve the performance of a network. In particular, if the network is a heterogenous multi-layer network, such as an overlay network formed based on tunneling and virtual private networks (VPNs), a switch of the network may need to learn the accessibility information associated with the virtual address at different layers. For example, the switch may learn the virtual address based on the overlay routing for a VPN over the tunnels, such as an Ethernet VPN (EVPN), that can be deployed as an overlay over a set of virtual extensible local area networks (VXLANs). To deploy a VPN over the tunnels, a respective tunnel endpoint may map a respective client virtual local area network (VLAN) to a corresponding tunnel network identifier (TNI), which can identify a virtual network for a tunnel. When a switch in the fabric learns an address, which can be the virtual address, the switch can share the address with other switches via an overlay route packet.

The TNI may appear in a tunnel header that encapsulates the overlay route packet and is used for forwarding the encapsulated packet via a tunnel. For example, if the tunnel is formed based on VXLAN, the TNI can be a virtual network identifier (VNI) of a VXLAN header, and a tunnel endpoint can be a VXLAN tunnel endpoint (VTEP). A TNI can also be mapped to the virtual routing and forwarding (VRF) associated with the tunnels if layer-3 routing and forwarding are needed. Since a VPN can be distributed across the tunnel fabric, a VPN over the tunnel fabric can also be referred to as a distributed tunnel fabric. Since the fabric is an overlay network, a respective switch in the fabric can be a tunnel endpoint of one or more tunnels. Furthermore, a gateway switch of the fabric can be a virtual gateway switch (VGS) shared among a plurality of participating switches.

The aspects described herein solve the problem of efficiently learning a virtual address distributed across an overlay network by (i) performing a deep-packet inspection (DPI) on packets associated with the virtual address to determine a priority value indicating the order of association; (ii) including the priority value in the overlay route packets for sharing the virtual address; and (iii) using the priority value to prevent MAC address dampening and select an active device for the virtual address. Upon identifying the priority value in the packet, a respective receiving switch of the overlay network may determine that MAC address dampening should be disabled for the virtual address. Furthermore, the switch can select which device should be the active device based on the priority values. As a result, even if the virtual address is distributed across the overlay network, the switches in the overlay network can efficiently learn the virtual address.

A distributed tunnel fabric in an overlay network can be coupled to other networks via the gateway switch, which can include a VGS, of the fabric. Typically, at least two switches can operate as a single switch in conjunction with each other to facilitate the VGS. Switches participating in the VGS can be referred to as participating switches. A respective participating switch can consider the other participating switches as peer participating switches (or peer switches). A respective pair of participating switches can be coupled to each other via an inter-switch link (ISL). The VGS can be associated with one or more virtual addresses (e.g., a virtual Internet Protocol (IP) address and/or a virtual media access control (MAC) address). A respective tunnel formed at the VGS can use the virtual address to form the tunnel endpoint. As a result, other tunnel endpoints (i.e., other switches) of the fabric can consider the VGS as the other tunnel endpoint for a tunnel instead of any of the participating switches. Even though a switch in a distributed tunnel fabric may not be a

To forward traffic toward the VGS, a respective switch in the fabric can perform a load balancing operation (e.g., based on hashing on a respective packet) and select one of the participating switches as the destination (i.e., as the other tunnel endpoint). The switch can then forward the packet via a tunnel between the tunnel endpoints. Hence, an endpoint may forward a multicast control packet to one of the participating switches, which in turn, can share the control packet with a peer participating switch via the ISL. If the fabric is a multi-fabric network, the fabric can be one of a plurality of fabrics forming the network. A respective fabric can then include a gateway switch, which can include a VGS, that can be coupled to a remote gateway switch of another fabric, an external network, or both.

For example, the gateway switch can be coupled to the remote gateway switch via an inter-fabric tunnel (i.e., a tunnel coupling two fabrics). A packet received at the gateway switch via an intra-fabric tunnel (i.e., a tunnel within a fabric) can be encapsulated with a tunnel header associated with the intra-fabric tunnel. The gateway switch can decapsulate the tunnel header and re-encapsulate the packet with another tunnel header associated with the inter-fabric tunnel. A respective switch operating as a tunnel endpoint in the fabric can use a routing protocol, such as Border Gateway Protocol (BGP). In a multi-fabric overlay network, routes for intra-fabric tunnels can be determined by using internal BGP (iBGP) while the routes for inter-fabric tunnels can be determined by using external BGP (eBGP).

Many protocols in a network use virtual addresses for access. For example, multiple devices functioning as a single virtual device based on VRRP can be assigned a single virtual MAC address, which can be used as the source MAC address in the control packets. If the devices are switches, the virtual device can be a virtual switch. However, one of the devices can be the primary device and use the virtual MAC address as the source MAC address for the data packets in the data plane. If the devices are distributed across the overlay network (e.g., across one or more overlay tunnel fabrics), the access switches of the overlay network coupling them may learn the same virtual MAC address from the control packets. However, the underlying fabric control plane (e.g., the EVPN control plane) may require sharing of learned MAC addresses in the overlay network. The access switches can use a fabric route packet to notify other switches regarding a learned MAC address.

Accordingly, each of these access switches can advertise the virtual MAC address in the overlay network. Hence, the switches in the network may perceive that the MAC address is migrating. If the migration occurs more than a threshold number of times, the fabric control plane on the switches may perform a MAC address dampening operation, which restricts the learning of the virtual MAC address for a predefined period. However, if the primary device becomes unavailable during the MAC address dampening period, the standby devices would not be able to provide high availability because the virtual MAC address may not be learned by the access switch coupling the new primary device.

To solve this problem, a respective access switch can perform a DPI on the control packets received from a device associated with the virtual address and determine the priority value associated with the device. The primary device can be associated with the highest priority value. Upon learning the virtual MAC address based on the control packet, the switch can store the virtual MAC address, the ingress interface of the control packet, and the corresponding priority value in the local routing data structure (e.g., in the routing information base (RIB)). The switch also can generate a fabric route packet (e.g., an EVPN type 2 route update packet) that can include the virtual MAC address as well as the priority value. The switch can then send the fabric route packet via a respective tunnel coupling the switch. This allows another switch of the overlay network to learn the virtual MAC address and the priority value in association with the ingress tunnel of the fabric route packet.

When the other switch receives a fabric route packet comprising the priority value, the receiving switch can pause the MAC address dampening for the MAC address in the packet and prevent the dampening period from coinciding with a potential failover event. Furthermore, the priority values can allow the switch to determine the order in which the devices can take over the role of the primary device. When the switch receives the fabric route packet, the switch can store the virtual MAC address, the ingress tunnel of the packet, and the corresponding priority value in the local routing data structure. As a result, even when the virtual MAC address is learned from different tunnels (or interfaces), the switch can determine the primary device based on the priority values. Accordingly, the switch can program the entry with the most significant priority in the local forwarding data structure (e.g., in the forwarding information base (FIB)). Here, the most significant priority can be indicated by the highest or lowest priority value.

Moreover, if the primary device becomes unavailable, the switch coupling the unavailable device can generate another fabric route packet indicating the unavailability and distribute the packet in the overlay network. Upon receiving the packet, another switch of the overlay network can become aware of the unavailability. Instead of waiting for the underlying protocol, such as VRRP, associated with the virtual address to converge, the switch can determine which standby device can take over the role of the new primary device based on the priority values. Accordingly, the switch can program the entry corresponding to the new primary device in the local forwarding data structure. Consequently, traffic to the virtual MAC address can be redirected toward the new primary device. This allows the switches to readily change routes while the new primary device is elected based on the protocol.

In this disclosure, the term “switch” is used in a generic sense, and it can refer to any standalone or fabric switch operating in any network layer. “Switch” should not be interpreted as limiting examples of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

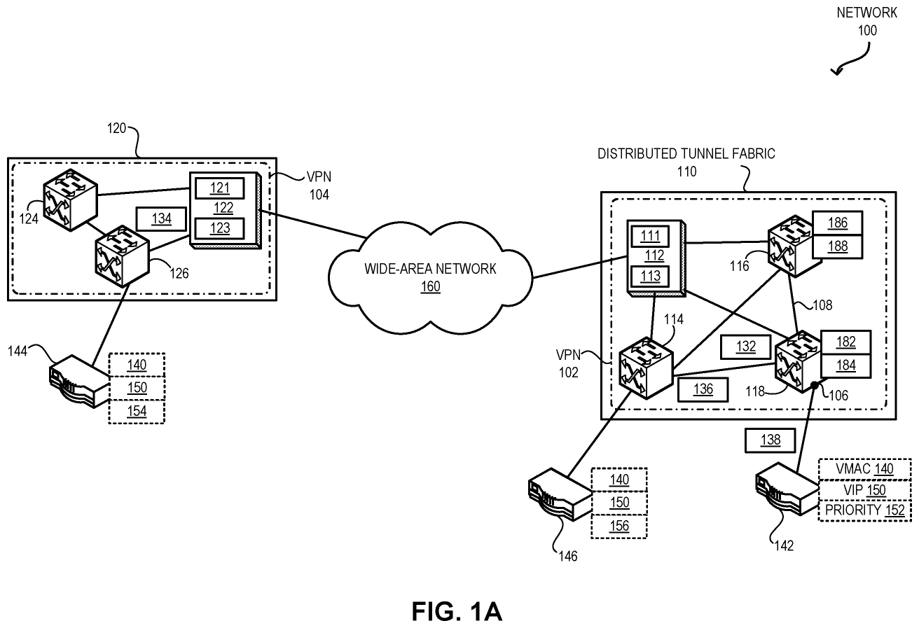

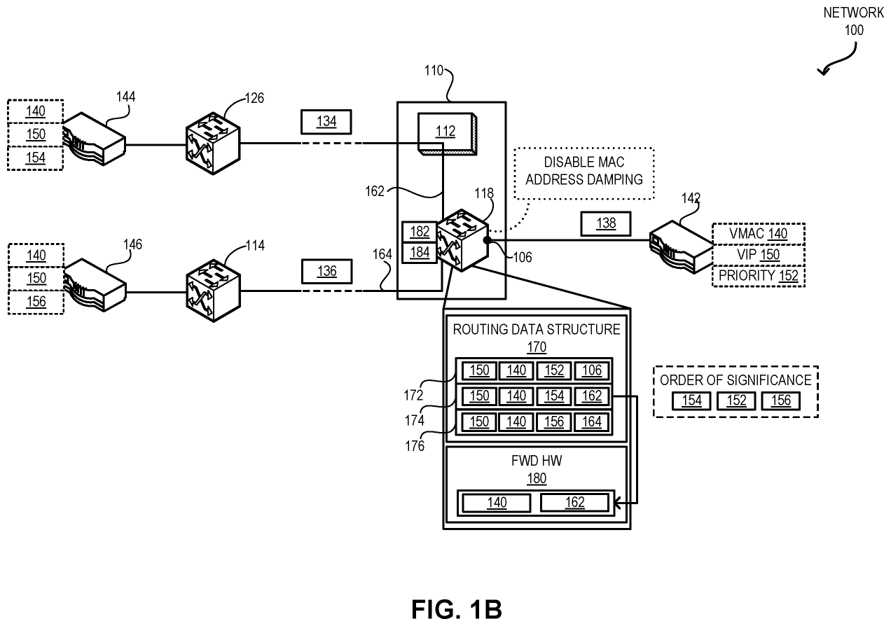

FIG. 1A illustrates an example of an overlay network facilitating efficient learning of virtual addresses, in accordance with an aspect of the present application. An overlay network 100 can include a number of switches and devices, and may include heterogeneous network components, such as layer-2 and layer-3 hops, and tunnels. In some examples, network 100 can be an Ethernet, InfiniBand, or other networks, and may use a corresponding communication protocol, such as Internet Protocol (IP), FibreChannel over Ethernet (FCOE), or other protocol. Network 100 can include a plurality of distributed tunnel fabrics 110 and 120. Hence, network 100 can be a multi-fabric network. Fabric 110 can include switches 111, 113, 114, 116, and 118; and fabric 120 can include switches 121, 123, 124, and 128. A respective switch in a respective fabric can be associated with a MAC address and an IP address. In a respective fabric of network 100, switches can be coupled to each other via a tunnel.

In FIG. 1A, a respective link denoted with a solid line between a switch pair can indicate a tunnel. Switches of a respective fabric in network 100 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). The tunnels in a fabric can be formed over an underlying network (or an underlay network). The underlying network can be a physical network, and a respective link of the underlying network can be a physical link. A respective switch pair in the underlying network can be a Border Gateway Protocol (BGP) peer. A VPN 102, such as an Ethernet VPN (EVPN), can be deployed over fabric 110. Similarly, a VPN 104 can be deployed over fabric 120.

A VGS 112 can operate as the gateway switch of fabric 110 and facilitate external communication of fabric 110. In fabric 110, switches 111 and 113 can operate as a single switch in conjunction with each other to facilitate VGS 112. Similarly, VGS 122 can operate as the gateway switch of fabric 120 and facilitate external communication of fabric 120. In fabric 120, switches 121 and 123 can operate as a single switch in conjunction with each other to facilitate VGS 122. VGS 112 and 122 can couple fabrics 110 and 120, respectively, to a wide-area network (WAN) 160, such as an enterprise network or the Internet.

In fabric 110, switches 111 and 113 can operate as a single switch in conjunction with each other to facilitate VGS 112. VGS 112 can be associated with one or more virtual addresses (e.g., a virtual IP address and/or a virtual MAC address). A respective tunnel formed at VGS 112 can use the virtual address to form the tunnel endpoint. To efficiently manage data forwarding, switches 111 and 113 can maintain an ISL between them for sharing control and/or data packets. The ISL can be a layer-2 or layer-3 connection that allows data forwarding between switches 111 and 113. The ISL can also be based on a tunnel between switches 111 and 113 (e.g., a VXLAN tunnel).

Because the virtual address of VGS 102 is associated with both switches 113 and 113, other tunnel endpoints, such as switches 114, 116, and 118, of fabric 110 can consider VGS 112 as the other tunnel endpoint for a tunnel instead of switches 111 and 113. To forward traffic toward VGS 112 in fabric 110, a remote switch, such as switch 114, 116, or 118, can operate as a tunnel endpoint while VGS 112 can be the other tunnel endpoint. From a respective remote switch of fabric 110, there can be a set of paths (e.g., equal-cost multiple paths or ECMP) to VGS 112. For example, the ECMP can include a path to switch 111 and another path to switch 113. Hence, a respective path in the underlying network can lead to one of the participating switches of VGS 112.

In network 100, VGS 112 can be coupled to VGS 122 via an inter-fabric tunnel (i.e., a tunnel coupling fabrics 110 and 120). A packet between fabrics 110 and 120 can be received at VGS 112 via an intra-fabric tunnel within fabric 110 and can be encapsulated with a tunnel header associated with the intra-fabric tunnel. VGS 112 can decapsulate the tunnel header and re-encapsulate the packet with another tunnel header associated with the inter-fabric tunnel. Upon receiving the packet, VGS 122 can decapsulate the tunnel header and re-encapsulate the packet with another tunnel header associated with the intra-fabric tunnel to send the packet to the intended recipient. To facilitate the forwarding of the packet, VGS 112 can determine routes for intra-fabric tunnels using iBGP and routes for inter-fabric tunnels using eBGP.

Many protocols in network 100 can use virtual addresses for access. For example, multiple devices 142, 144, and 146 functioning as a single virtual device (not shown in FIG. 1A) based on VRRP can be assigned a single virtual MAC address 140. Similarly, devices 142, 144, and 146 can be associated with a single virtual IP address 150. Virtual MAC address 140 can be the source MAC address of the control packets sent from devices 142, 144, and 146. If devices 142, 144, and 146 are switches, the virtual device can be a virtual switch. On the other hand, if devices 142, 144, and 146 are servers that provide a shared set of services, the virtual device can be a virtual server. Typically, one of devices 142, 144, and 146, such as device 144, can be the primary device and use virtual MAC address 140 as the source MAC address for the data packets in the data plane.

Devices 142, 144, and 146 can be distributed across network 100. Devices 142 and 146 can be coupled to switches 118 and 114 of fabric 110 while device 144 can be coupled to switch 126 of fabric 120. When the protocol daemon (e.g., a VRRP daemon) instances on devices 142, 144, and 146 are initialized, devices 142, 144, and 146 can send a control message to switches 118, 126, and 114, respectively. For example, device 142 can send a control packet 138 to switch 118 with virtual MAC address 140 as the source address. Accordingly, switch 118 can receive control packet 138 via the local port 106 coupling device 142 and learn virtual MAC address 140 from a source address field of a header of packet 138. The underlying fabric control plane (e.g., the EVPN control plane) of switch 118 can then share the learning of virtual MAC address 140 with other switches of network 100. In the same way, switches 126 and 114 can also share the learning of virtual MAC address 140 upon learning it from devices 144 and 146, respectively.

Because multiple switches can advertise virtual MAC address 140 in network 100, the switches in network 100 may perceive that virtual MAC address 140 is migrating. If the migration occurs more than a threshold number of times, the fabric control plane on network 100 may perform a MAC address dampening operation, which restricts the learning of virtual MAC address 140 for a period. However, if primary device 144 becomes unavailable during the MAC address dampening period, devices 142 and 146 would not be able to provide high availability to device 144 because virtual MAC address 140 may not be learned by switches 118 and 144.

To solve this problem, switch 118 can deploy a priority management system 182. System 182 can snoop packet 138 and perform a DPI on packet 138 received from device 142. The DPI allows system 182 to determine a priority value 152 associated with device 142. Priority value 152 can indicate an order in which device 142 can be selected for providing a service based on the protocol. For example, if the protocol is VRRP, Priority value 152 can indicate an order in which device 142 can be selected as the primary device. System 182 may determine priority value 152 based on the protocol priority defined for the protocol associated with virtual MAC address 140.

If virtual MAC address 140 is defined for VRRP, priority value 152 can be determined from the priority value associated with VRRP. Priority value 152 can be the same as the value of the protocol priority or a derived value (e.g., a smaller value). Priority value 152 can be consistent with the order of significance defined for the protocol. As a result, priority value 152 can indicate the order in which the primary device should be selected. For example, since there are three devices associated with virtual MAC address 140, the derived values can be 0, 1, and 2. These values can be allocated to devices 142, 144, and 146 in accordance with the order of significance.

In the same way, switches 126 and 114 can determine priority values 154 and 156 associated with devices 144 and 146, respectively. The primary device can be associated with the most significant (e.g., the highest or the lowest) priority value among priority values 152, 154, and 156. Upon learning virtual MAC address 140 from packet 138, switch 118 can store virtual MAC address 140, ingress port 106, and priority value 152 in the local routing data structure. Daemon 184 can be responsible for managing information consistency in network 100. Daemon 184 can also generate a fabric route packet 132 that can include virtual MAC address 140 and priority value 152.

Packet 132 can include a set of fields dedicated to priority value 152. For example, if packet 132 is an EVPN type 2 route update packet, packet 132 can include a transitive and optional extended community, which can be referred to as a MAC priority community. Dameon 184 can send packet 132 via a respective tunnel coupling switch 118. This allows other switches of network 100 to learn virtual MAC address 140 and priority value 152. For example, upon receiving packet 132 via tunnel 108, fabric daemon 188 of switch 116 can learn virtual MAC address 140 and priority value 152 and store them in association with tunnel 108 in the local routing data structure.

Similarly, when switch 126 learns virtual MAC address 140 and priority 154 from device 144, the fabric daemon of switch 126 can send fabric route packet 134 to notify other switches of network 100. In the same way, when switch 114 learns virtual MAC address 140 and priority 156 from device 146, the fabric daemon of switch 114 can send fabric route packet 136 to notify other switches of network 100. Daemon 188 can then learn virtual MAC address 140 and associated priorities from the fabric route packets. When switch 116 receives fabric route packets comprising respective priority values from all devices associated with virtual MAC address 140, daemon 188 can pause the MAC address dampening for virtual MAC address 140 and prevent the dampening period from coinciding with a potential failover event. However, if any of packets 132, 134, and 136 do not include the corresponding priority value, daemon 188 may not pause the dampening for virtual MAC address 140.

Furthermore, priority values 152, 154, and 156 can allow priority management system 186 of switch 116 to determine the order in which devices 142, 144, and 146, respectively, can take over the role of the primary device for virtual MAC address 140. Daemon 188 can store virtual MAC address 140 and the corresponding priority values in the local routing data structure. As a result, even when switch 116 learns virtual MAC address 140 from different sources, system 186 can determine the primary device based on the priority values. Accordingly, system 186 can program the entry with the most significant priority in the local forwarding data structure. Moreover, if the primary device becomes unavailable, system 186 can select the standby device associated with the next significant priority from the data structure and program it for virtual MAC address 140. Consequently, traffic to virtual MAC address 140 can be redirected toward the new primary device. This allows switch 116 to readily change routes while the new primary device is elected based on the protocol (e.g., VRRP).

FIG. 1B illustrates an example of a switch in a distributed tunnel fabric efficiently learning and distributing a virtual address and an associated priority value, in accordance with an aspect of the present application. During operation, switch 118 can receive packet 138 from device 142. System 182 can then perform a DPI on packet 138. Switch 118 can be programmed with a rule (e.g., an access control list (ACL) rule) that can allow the forwarding hardware of switch 118 to determine which packets to snoop and perform the DPI. For example, the rule can be defined for VRRP control packets. Hence, if packet 138 is a VRRP control packet, the rule can indicate that a VRRP control packet received from an edge port should be selected for snooping. The rule can also preclude system 182 from snooping VRRP control packets received via a tunnel.

Upon learning virtual MAC address 140 from packet 138, system 182 can provide the learned information to daemon 184. System 182 may also cache virtual MAC address 140 and corresponding priority value 152. For subsequent control packets from device 142, system 182 can check the cache to determine whether any change is detected. For example, the priority value 152 of device 142 can change. As a result, the order of significance for priority value 152 may change. If a change is detected, system 182 may act accordingly. For example, if priority value 152 becomes the most significant one due to the change, system 182 can select device 142 as the primary device.

Daemon 184 can store virtual MAC address 140, ingress port 106, and priority value 152 in entry 172 of local routing data structure 170. Entry 172 may also include virtual IP address 150 in association with virtual MAC address 140. Switch 118 can also receive packet 134 from switch 126 via tunnel 162 coupling VGS 112 (e.g., based on inter-fabric and intra-fabric encapsulation and decapsulation). Daemon 184 can learn virtual MAC address 140 and may obtain priority value 154 from packet 134. if packet 134 is an EVPN type 2 route update packet, packet 134 can indicate that virtual MAC address 140 has been learned in network 100. Packet 134 can also include an extended community indicating priority value 154. Daemon 184 can then store virtual MAC address 140, ingress tunnel 162, and priority value 154 in entry 174 of routing data structure 170. In the same way, switch 118 can also receive packet 136 from switch 114 via tunnel 164. Daemon 184 can then learn virtual MAC address 140 and obtain priority value 156. Daemon 184 can store virtual MAC address 140, ingress tunnel 164, and priority value 156 in entry 176 of routing data structure 170.

Since switch 118 has received respective priority values 152, 154, and 156 associated with virtual MAC address 140, daemon 184 can pause the MAC address dampening for virtual MAC address 140. Furthermore, priority values 152, 154, and 156 can allow system 182 to determine the order in which devices 142, 144, and 146, respectively, can take over the role of the primary device for virtual MAC address 140. Hence, the order of significance of priority values 152, 154, and 156 can indicate which device should be selected as the primary device. If priority value 154 is the most significant, system 182 can determine device 144 as the primary device based on the significance of priority value 154 in entry 174. Accordingly, switch 118 can program an entry in forwarding hardware 180 of switch 118 based on entry 174.

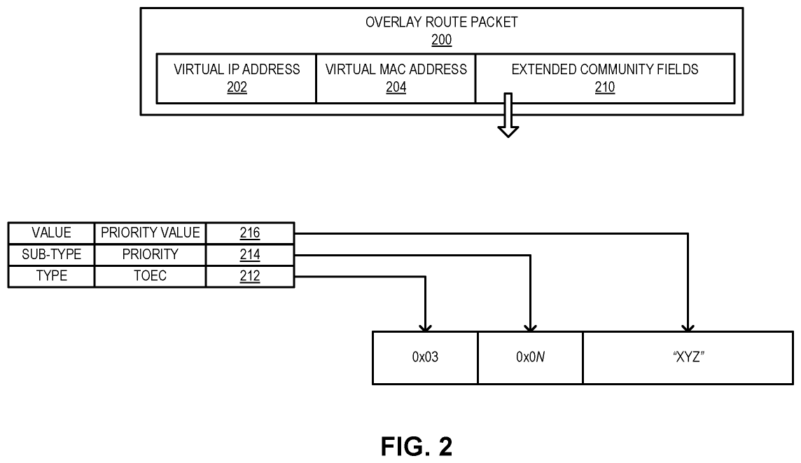

FIG. 2 illustrates an example of an overlay route packet for notifying a virtual address and an associated priority value in an overlay network, in accordance with an aspect of the present application. An overlay route packet 200, such as an EVPN type 2 route update, can be used to advertise a virtual MAC address. Packet 200 can then include a field 202 to include a virtual IP address and another field 204 to include a virtual MAC address. Packet 260 can also include a set of extended community fields 210 to indicate the priority value associated with the source from where virtual MAC address 140 is learned. Community fields 210 can represent a BGP Extended Communities Attribute, as defined in Internet Engineering Task Force (IETF) Request For Comments (RFC) 4360. For example, community fields 210 can indicate Transitive Opaque Extended Community (TOEC).

Community fields 210 can include a set of sub-fields representing the priority value. The set of sub-fields can include a type 212, a sub-type 214, and a value 216. Type 212 can indicate the generic type of field (e.g., a TOEC field) that can be defined in accordance with the standard (e.g., the BGP Extended Communities Attribute) associated with community fields 210. Sub-type 214 can be a specialized value indicating that community fields 210 corresponds to a priority value. Value 216 can then indicate the priority value. Accordingly, type 212 can include a value of “0x03,” which can indicate a TOEC field. Sub-type 214 can include a specialized value of “0x0N.”

Any switch that supports sub-type 214 can recognize the specialized value and determine that fields 210 includes information indicating a priority value and can obtain the corresponding priority value specified in value 216 (e.g., a priority value of “XYZ”). Community fields 210 can be transitive because the community can be defined to be opaque for interoperability based on TOEC. As a result, if a switch does not support sub-type 214, the regular route advertisement can remain operational in the network. Furthermore, since community fields 210 can be relayed via a tunnel, the switch can relay community fields 210 to upstream switches even if the switch does not support sub-type 214. Consequently, the efficient learning of virtual MAC address 140 can be supported in a heterogeneous overlay network with switches distributed in multiple fabrics.

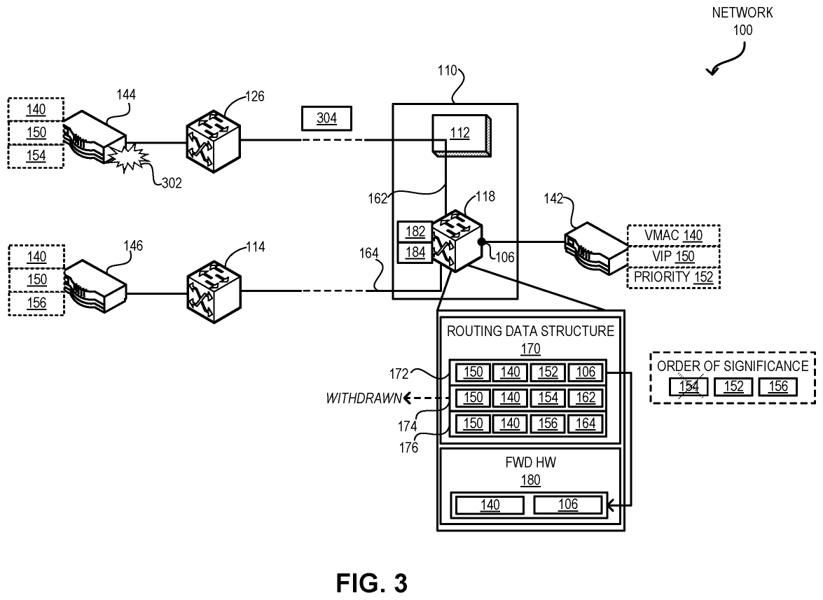

FIG. 3 illustrates an example of an efficient failover for a virtual address based on associated priority values, in accordance with an aspect of the present application. The order of significance for priority values 152, 154, and 156 can allow switch 118 to determine the order in which devices 142, 144, and 146, respectively, can take over the role of the primary device for virtual MAC address 140. If priority value 154 is the most significant one, device 144 can be elected as the primary device associated with virtual MAC address 140. Suppose that primary device 144 becomes unavailable due to an event 302 (e.g., a link or node failure, a power cycle, or a scheduled update).

Switch 126 coupling device 144 can generate fabric route packet 304 indicating the unavailability of device 144. Switch 126 can then send packet 304 in network 100. Upon receiving packet 304 via tunnel 162, switch 118 can become aware of the unavailability. Switch 118 can then withdraw entry 174 associated with device 144 from routing data structure 170. Therefore, switch 118 is precluded from considering priority value 154 for selecting the primary device. Instead of waiting for the underlying protocol, such as VRRP, associated with virtual MAC address 140 to converge, switch 118 can determine which standby device can take over the role of the new primary device based on remaining priority values 152 and 156. Suppose that priority value 152 is more significant than priority value 156. Accordingly, switch 118 can select device 142 as the new primary device associated with virtual MAC address 140.

Switch 118 can then program entry 172 corresponding to primary device 142 in forwarding hardware 180. Consequently, traffic to virtual MAC address 140 can be redirected toward device 142 via interface 106. This allows switch 118 to readily change routes in forwarding hardware 180 while protocol daemon 350 (e.g., the VRRP daemon) performs the primary device election process. Because protocol daemon 350 can also use remaining priority values 152 and 156 to elect the next primary device, protocol daemon 350 can independently elect device 142 as the primary device and instruct forwarding hardware 180 to program interface 106 as the forwarding interface for virtual MAC address 140. By preprogramming such an entry in forwarding hardware 180, switch 118 can facilitate fast convergence for the failover process.

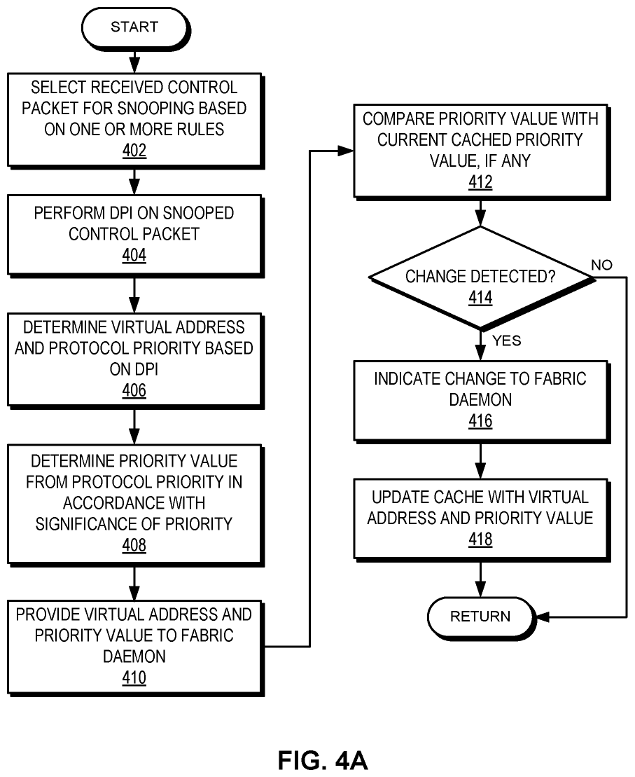

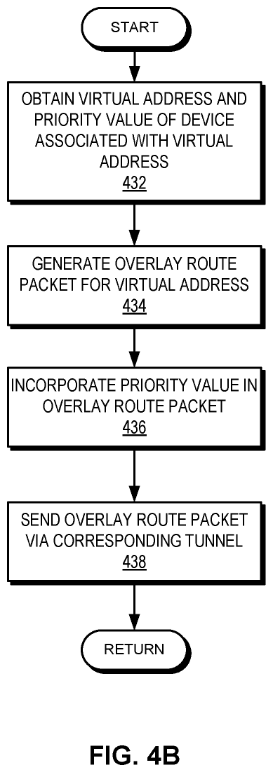

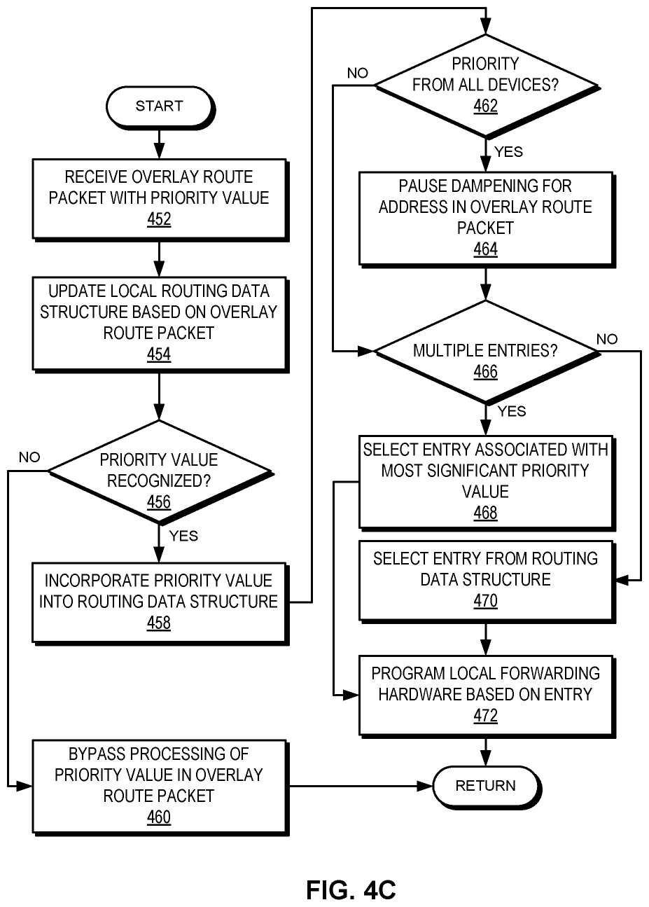

FIG. 4A presents a flowchart illustrating the process of a switch learning a virtual address and an associated priority value, in accordance with an aspect of the present application. The operations associated with the process can be supported by a priority management system of the switch. During operation, the switch can select a received control packet for snooping based on one or more rules (operation 402). For example, if the control packet is a VRRP control packet, one of the rules can indicate that VRRP control packets should be snooped upon receiving from an edge port. Another rule may preclude the switch from snooping VRRP control packets received via a tunnel. The switch can then perform DPI on the snooped control packet (operation 404) and determine a virtual address and a protocol priority (e.g., VRRP priority) based on the DPI (operation 406).

The switch may determine a priority value from the protocol priority in accordance with the significance of priority (operation 408). The switch can then provide the virtual address and the priority value to the fabric daemon (e.g., the EVPN daemon) (operation 410). The switch can also compare the priority value with the currently cached priority value if any (operation 412). The switch can determine whether a change is detected (operation 414). If a change is detected, the switch can indicate the change to the fabric daemon (operation 416) and update the cache with the virtual address and the priority value (operation 418).

FIG. 4B presents a flowchart illustrating the process of a switch distributing a virtual address and an associated priority value in an overlay network, in accordance with an aspect of the present application. The operations associated with the process can be supported by a fabric daemon of the switch. During operation, the switch can obtain a virtual address and a priority value of a device associated with the virtual address (operation 432). The switch can generate an overlay route packet for the virtual address (operation 434) and incorporate the priority value in the overlay route packet (operation 436). The switch can then send the overlay route packet via a corresponding tunnel (operation 438). The switch can generate an overlay route packet with the virtual address and the priority value for a respective tunnel coupling the switch, thereby distributing the information in the overlay network.

FIG. 4C presents a flowchart illustrating the process of a switch programming a virtual address based on an associated priority value, in accordance with an aspect of the present application. During operation, the switch can receive an overlay route packet with a priority value (operation 452) and update a local routing structure based on the overlay route packet (e.g., by creating an entry or updating the entry) (operation 454). The switch can determine whether the priority value in the overlay route packet is recognized (operation 456). If the priority value is recognized, the switch can incorporate the priority value into the routing data structure (operation 458).

On the other hand, if the priority value is not recognized, the switch can bypass the processing of the priority value in the overlay route packet (operation 460). Upon handling the priority value, the switch can also determine whether the priority value is received from all devices associated with an address in the overlay route packet (operation 462). If the priority value is received from all devices, the switch can pause the dampening for the address in the overlay route packet (operation 464). Upon determining whether the priority value is received from all devices (operation 462) or pausing the dampening (operation 464), the switch can determine whether there are multiple entries associated with the address in the overlay route packet (operation 466).

If there are multiple entries, the switch can select the entry associated with the most significant priority value (operation 468). On the other hand, if there aren't multiple entries, the routing data structure can include a single entry for the address. The switch can then select the entry from the routing data structure (operation 470). Upon selecting the entry (operation 468 or 470), the switch can program the local forwarding hardware based on the entry (operation 472). This allows the forwarding hardware to forward packets destined to the address toward the device with the most significant priority value.

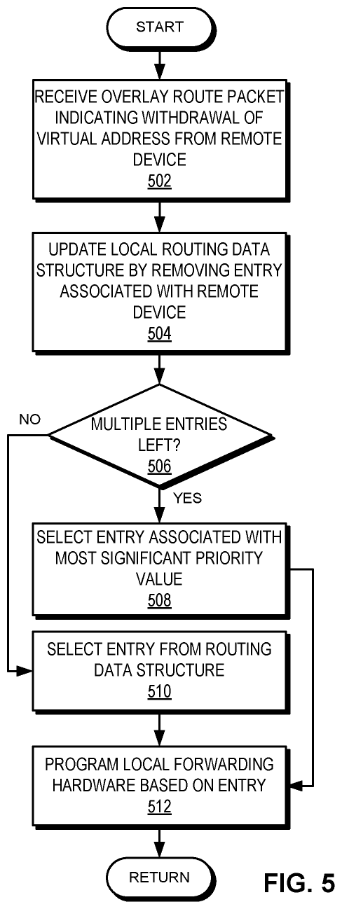

FIG. 5 presents a flowchart illustrating the process of a switch facilitating failover associated with a virtual address, in accordance with an aspect of the present application. During operation, the switch can receive an overlay route packet indicating the withdrawal of the virtual address from a remote device (operation 502). The switch can then update a local routing structure by removing the entry associated with the remote device (operation 504). Subsequently, the switch can determine whether there are multiple entries associated with the virtual address left (operation 504).

If there are multiple entries left, the switch can select the entry associated with the most significant priority value (operation 508). On the other hand, if there aren't multiple entries left, the routing data structure can include a single entry for the virtual address. The switch can then select the entry from the routing data structure (operation 510). Upon selecting the entry (operation 508 or 510), the switch can program the local forwarding hardware based on the entry (operation 512).

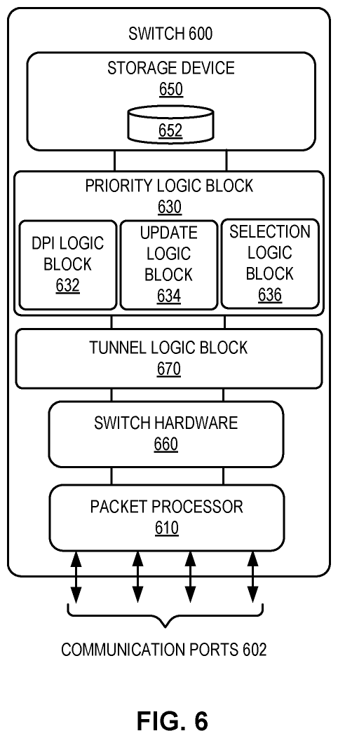

FIG. 6 illustrates an example of a switch supporting efficient learning of virtual addresses, in accordance with an aspect of the present application. In this example, a switch 600 can include a number of communication ports 602, a packet processor 610, and a storage device 650. Switch 600 can also include switch hardware 660 (e.g., processing hardware of switch 600, such as its application-specific integrated circuit (ASIC) chips), which includes information based on which switch 600 processes packets (e.g., determines output ports for packets). Packet processor 610 can extract and processes header information from the received packets. Packet processor 610 can identify a switch identifier (e.g., a MAC address and/or an IP address) associated with switch 600 in the header of a packet.

Communication ports 602 can include inter-switch communication channels for communication with other switches and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Switch 600 can maintain a database 652 (e.g., in storage device 650). Database 652 can be a relational database and may run on one or more Database Management System (DBMS) instances. Database 652 can store information associated with the routing, configuration, and interfaces of switch 600. Database 652 may store the routing data structure (e.g., an RIB) for switch 600. Switch 600 can include a tunnel logic block 670 that can establish a tunnel with a remote switch in an overlay network, thereby allowing switch 600 to operate as a tunnel endpoint. Switch 600 can include a priority logic block 630 that can allow switch 600 to efficiently learn a virtual address associated with multiple devices across the overlay network.

Priority logic block 630 can include a DPI logic block 632, an update logic block 634, and a selection logic block 636. DPI logic block 632 can select a control packet for snooping based on one or more rules (e.g., programmed in switch hardware 660). DPI logic block 632 can also snoop the control packet and perform DPI on the control packet to determine a priority value associated with a virtual address based on the control packet. Priority logic block 630 can pause the MAC address dampening upon obtaining all priority values associated with a virtual address. Update logic block 634 can update a local routing data structure based on information, which can include the priority value, from the control packet. Update logic block 634 can also notify a respective remote switch of the network regarding the virtual address and the priority value. Selection logic block 636 can select the primary device based on the significance of the priority values. Selection logic block 636 can also select a new primary device to facilitate failover based on the significance of the rest of the priority values.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a system for efficiently learning a virtual address in a network. During operation, the system can receive, from a first device, a control packet associated with a network protocol that operates based on a virtual address allocated to a plurality of devices. The plurality of devices can include the first device and provides a service using the virtual address. If the control packet is associated with the protocol, the system can perform a deep packet inspection on the control packet. Based on the inspection, the system can determine a first priority value indicated in the control packet. The first priority value can indicate an order in which the first device provides the service based on the protocol. The system can then generate, for a remote switch in the network, a notification packet comprising the virtual address and the first priority value, thereby allowing the remote switch to learn the virtual address in association with the first priority value.

In a variation on this aspect, the protocol can include Virtual Router Redundancy Protocol (VRRP). The first priority value can then indicate an order in which the first device is selected as a primary VRRP device for the virtual address.

In a variation on this aspect, the network can include an overlay tunnel fabric comprising a plurality of tunnels. The switch and the remote switch can then be coupled via a tunnel.

In a further variation, the fabric can include an Ethernet virtual private network (EVPN). The notification packet can then include an EVPN route update.

In a further variation, the first priority value can be included in a transitive extended community in the EVPN route update.

In a variation on this aspect, the system can learn the virtual address from a source address field of a header of the control packet received via a local port.

In a variation on this aspect, the system can receive, for a second switch in the network, a notification packet comprising the virtual address associated with a second device and a second priority value. Here, the second priority value can indicate an order in which the second device provides the service based on the protocol. The system can store the virtual address in a local routing data structure in association with the second priority value. The local routing data structure can also include the virtual address in association with the first priority value. The system can then select a primary device associated with the virtual address from the first and second devices based on the first and second priority values.

In a variation on this aspect, upon determining the unavailability of the primary device, the system can select a new primary device and program the virtual address in forwarding hardware of the switch in association with the new primary device prior to receiving an update from the protocol.

In a variation on this aspect, the system can determine whether the switch has received corresponding priority values for all devices associated with the virtual address. Upon receiving corresponding priority values for all devices, the system can pause address dampening in the network, wherein the address dampening prevents learning the virtual address in the network for a predefined period.

In a variation on this aspect, the system can maintain a cache associated with the virtual address and determine whether the first priority value has changed from a previous priority value stored in the cache.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
receiving, by a switch in a network from a first device, a control packet associated with a network protocol that operates based on a virtual address allocated to a plurality of devices, wherein the plurality of devices includes the first device and provides a service using the virtual address;
in response to the control packet being associated with the protocol, performing, at the switch, a deep packet inspection on the control packet;
determining, based on the inspection, a first priority value indicated in the control packet, wherein the first priority value indicates an order in which the first device provides the service based on the protocol; and
generating, for a remote switch in the network, a notification packet comprising the virtual address and the first priority value, thereby allowing the remote switch to learn the virtual address in association with the first priority value.

2. The method of claim 1, wherein the protocol includes Virtual Router Redundancy Protocol (VRRP), and wherein the first priority value indicates an order in which the first device is selected as a primary VRRP device for the virtual address.

3. The method of claim 1, wherein the network includes an overlay tunnel fabric comprising a plurality of tunnels, wherein the switch and the remote switch are coupled via a tunnel.

4. The method of claim 3, wherein the fabric includes an Ethernet virtual private network (EVPN), and wherein the notification packet includes an EVPN route update.

5. The method of claim 4, wherein the first priority value is included in a transitive extended community in the EVPN route update.

6. The method of claim 1, further comprising learning the virtual address from a source address field of a header of the control packet received via a local port.

7. The method of claim 1, further comprising:
receiving, for a second switch in the network, a notification packet comprising the virtual address associated with a second device and a second priority value, wherein the second priority value indicates an order in which the second device provides the service based on the protocol;
storing, in a local routing data structure, the virtual address in association with the second priority value, wherein the local routing data structure further includes the virtual address in association with the first priority value; and
selecting a primary device associated with the virtual address from the first and second devices based on the first and second priority values.

8. The method of claim 7, further comprising:
in response to determining unavailability of the primary device, selecting a new primary device; and
programming the virtual address in forwarding hardware of the switch in association with the new primary device prior to receiving an update from the protocol.

9. The method of claim 1, further comprising:
determining whether the switch has received corresponding priority values for all devices associated with the virtual address; and
in response to the switch receiving corresponding priority values for all devices, pausing address dampening in the network, wherein the address dampening prevents learning the virtual address in the network for a predefined period.

10. The method of claim 1, further comprising:
maintaining a cache associated with the virtual address; and
determining whether the first priority value has changed from a previous priority value stored in the cache.

11. A non-transitory computer-readable storage medium storing instructions that when executed by a processor of a switch of a network cause the processor to perform a method, the method comprising:
receiving, from a first device, a control packet associated with a network protocol that operates based on a virtual address allocated to a plurality of devices, wherein the plurality of devices includes the first device and provides a service using the virtual address;
in response to the control packet being associated with the protocol, performing, at the switch, a deep packet inspection on the control packet;
determining, based on the inspection, a first priority value indicated in the control packet, wherein the first priority value indicates an order in which the first device provides the service based on the protocol; and
generating, for a remote switch in the network, a notification packet comprising the virtual address and the first priority value, thereby allowing the remote switch to learn the virtual address in association with the first priority value.

12. The non-transitory computer-readable storage medium of claim 11, wherein the protocol includes Virtual Router Redundancy Protocol (VRRP), and wherein the first priority value indicates an order in which the first device is selected as a primary VRRP device for the virtual address.

13. The non-transitory computer-readable storage medium of claim 11, wherein the network includes an overlay tunnel fabric comprising a plurality of tunnels, wherein the switch and the remote switch are coupled via a tunnel.

14. The non-transitory computer-readable storage medium of claim 13, wherein the fabric includes an Ethernet virtual private network (EVPN), and wherein the notification packet includes an EVPN route update, and wherein the first priority value is included in a transitive extended community in the EVPN route update.

15. The non-transitory computer-readable storage medium of claim 11, wherein the method further comprises learning the virtual address from a source address field of a header of the control packet received via a local port.

16. The non-transitory computer-readable storage medium of claim 11, wherein the method further comprises:
receiving, for a second switch in the network, a notification packet comprising the virtual address associated with a second device and a second priority value, wherein the second priority value indicates an order in which the second device provides the service based on the protocol;
storing, in a local routing data structure, the virtual address in association with the second priority value, wherein the local routing data structure further includes the virtual address in association with the first priority value; and
selecting a primary device associated with the virtual address from the first and second devices based on the first and second priority values.

17. The non-transitory computer-readable storage medium of claim 16, wherein the method further comprises:
in response to determining unavailability of the primary device, selecting a new primary device; and
programming the virtual address in forwarding hardware of the switch in association with the new primary device prior to receiving an update from the protocol.

18. The non-transitory computer-readable storage medium of claim 11, wherein the method further comprises:
determining whether the switch has received corresponding priority values for all devices associated with the virtual address; and
in response to the switch receiving corresponding priority values for all devices, pausing address dampening in the network, wherein the address dampening prevents learning the virtual address in the network for a predefined period.

19. The non-transitory computer-readable storage medium of claim 11, wherein the method further comprises:
maintaining a cache associated with the virtual address; and
determining whether the first priority value has changed from a previous priority value stored in the cache.

20. A computer system, comprising:
a processor;
a memory device;
a communication port to receive, from a first device, a control packet associated with a network protocol that operates based on a virtual address allocated to a plurality of devices, wherein the plurality of devices includes the first device and provides a service using the virtual address;
control circuitry to facilitate an inspection logic block and an update logic block;
wherein the inspection logic block is to:
in response to the control packet being associated with the protocol, perform a deep packet inspection on the control packet; and
determine, based on the inspection, a first priority value indicated in the control packet, wherein the first priority value indicates an order in which the first device provides the service based on the protocol; and
wherein the update logic block is to generate, for a remote computer system in the network, a notification packet comprising the virtual address and the first priority value, thereby allowing the remote computer system to learn the virtual address in association with the first priority value.
